(19) United States
(12) Patent Application Publication
(10) Pub. No.: US 2024/0403699 A1
(43) Pub. Date: Dec. 5, 2024

(54) MACHINE-LEARNING-BASED PROXIMITY DETECTION USING IMPEDANCE

(71) Applicant: QUALCOMM Incorporated, San Diego, CA (US)

(72) Inventors: David Loweth WINSLOW, San Diego, CA (US); John BORO, Encinitas, CA (US); Diego CALZOLARI, San Diego, CA (US); John FORRESTER, San Diego, CA (US)

(21) Appl. No.: 18/326,509

(22) Filed: May 31, 2023

(51) Int. Cl. G06N 20/00; H04B 1/04

(52) U.S. Cl. CPC G06N 20/00; H04B 1/04

(57) ABSTRACT

Certain aspects of the present disclosure provide techniques and apparatus for improved machine learning. Impedance information for a wireless transmitter of a device is determined, and impedance change information is generated based on a difference between the impedance information and prior impedance information for the wireless transmitter. An off-body characteristic is generated based on processing the impedance change information using a trained machine learning model, where the off-body characteristic indicates a probability that the device was off-body when the impedance information was determined.

### INTRODUCTION

Aspects of the present disclosure relate to machine learning.

An increasingly wide variety of devices include components to provide wireless connectivity via a broad set of wireless technologies. Some wireless devices include proximity detection circuits or technologies in order to detect nearby bodies (e.g., the hand(s) of a user) or other objects. For example, some devices use capacitive sensors to detect the presence or proximity of a human. Such proximity detection may be used for a variety of purposes, such as radio frequency (RF) exposure mitigation (e.g., to adjust transmission power if a user is near the device), gesture detection, grip detection, and the like.

However, some conventional proximity sensor approaches (e.g., using capacitive sensors) have a variety of downsides for typical use. For example, additional or dedicated proximity/capacitive sensing circuits are often used or added to user devices, which increases manufacturing costs, increases printed wiring board (PWB) routing complexity, and increases the size of the PWB(s). Further, during use, these dedicated proximity circuits often consume additional power that otherwise would not be used, and further generate additional heat that otherwise would not be generated. These concerns are particularly pronounced in handheld and/or battery-powered devices, which make up a substantial portion of the wireless devices that use proximity detection.

### BRIEF SUMMARY

Certain aspects of the present disclosure provide a processor-implemented method, comprising: determining impedance information for a wireless transmitter of a device; generating impedance change information based on a difference between the impedance information and prior impedance information for the wireless transmitter; and generating an off-body characteristic based on processing the impedance change information using a trained machine learning model, wherein the off-body characteristic indicates a probability that the device was off-body when the impedance information was determined.

Certain aspects of the present disclosure provide a processor-implemented method, comprising: determining impedance information for a wireless transmitter of a device; generating impedance change information based on a difference between the impedance information and prior impedance information for the wireless transmitter; generating an off-body characteristic based on processing the impedance change information using a machine learning model, wherein the off-body characteristic indicates a probability that the device was off-body when the impedance information was determined; and updating one or more parameters of the machine learning model based on comparing the off-body characteristic with a ground truth label associated with the impedance information.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict certain aspects of the present disclosure and are therefore not to be considered limiting of the scope of this disclosure.

FIG. 1 depicts an example graph illustrating impedance information for proximity detection using machine learning.

FIG. 2 depicts an example workflow for training and using machine learning models to provide proximity detection based on impedance information.

FIG. 3 depicts an example workflow for augmenting impedance information to provide machine-learning-based proximity detection.

FIG. 4 is a flow diagram depicting an example method for augmenting impedance information to provide machine-learning-based proximity detection.

FIG. 5 is a flow diagram depicting an example method for training machine learning models to provide impedance-based proximity detection.

FIG. 6 is a flow diagram depicting an example method for using machine learning models to provide impedance-based proximity detection.

FIG. 7 is a flow diagram depicting an example method for impedance-based proximity detection.

FIG. 8 is a flow diagram depicting an example method for training models for impedance-based proximity detection.

FIG. 9 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatuses, methods, processing systems, and non-transitory computer-readable mediums for improved machine learning models that enable impedance-based proximity detection.

In some aspects, impedance measurements are generated or collected based on receiver feedback during transmission from one or more antennas on user devices (also referred to in some aspects as user equipment (UE)), such as smartphones. For example, components used to measure the voltage standing wave ratio (VSWR), which is a measure of how efficiently radio frequency (RF) power is being transmitted via the antenna, may be used to collect impedance information. In some aspects, such feedback-receiver-based impedance measurements are used by user devices to improve wireless communication, such as to perform operations including aperture tuner control, radiated power optimization, and the like. Accordingly, in some aspects, the available impedance information can be additionally used with improved machine learning techniques described herein to provide reliable proximity detection.

Generally, impedance is the opposition to the flow of energy through a system. Electronic signals with constant levels (e.g., DC signals) may have constant impedance, whereas time-varying electronic signals (e.g., AC signals) may have impedance that varies with changing frequency. Impedance generally has a complex value comprising a resistance component, which forms the “real” part of the value, and a reactance component, which forms the “imaginary” part of the value. In some aspects, in addition to or instead of evaluating “real” and “imaginary” components of the impedance, components of a polar coordinate system (e.g., having a magnitude component and direction component) may be used to represent the impedance.

Antenna impedance relates to the voltage and current looking into the input of an antenna. The “real” part of the antenna impedance represents power that is either radiated away or absorbed within the antenna, and the “imaginary” part of the impedance represents power that may be stored in the near field of the antenna (e.g., non-radiated power). An antenna is generally more efficient and thus more effective when impedance of the system is matched for the antenna.

Some aspects of the present disclosure enable machine-learning-based proximity detection in user devices based on collected antenna impedance information, thereby obviating the reliance on conventional proximity sensors. Advantageously, in some aspects, user devices that do not include or use capacitive sensors for proximity detection can perform one or more techniques described herein. In this way, by using impedance information rather than conventional sensors, such devices can operate with reduced power consumption, reduced chip complexity and size, and can further be constructed with reduced manufacturing costs of the device.

In some aspects, machine learning models are used to provide proximity detection using binary or probability-based output, such as generating a binary label and/or probability measure or characteristic indicating whether the user device is on-body (e.g., in the user's hand, resting on the user's body, and the like) or off-body (e.g., on a table or desk) when impedance information is collected. In some aspects, a variety of off-body cases that have differing impedance signatures can also be identified or predicted, such as whether the user device is in free space, whether the device is plugged in to a charging cable and on a desk, whether the device is in a protective case, and the like. Further, in some aspects, a variety of on-body cases can similarly be identified or predicted, such as whether the device is being held in the left hand, the right hand, or both hands, whether the device is being held in a portrait or landscape orientation, whether the device is on-body and also plugged into a charger, and the like.

In some aspects, in addition to the current impedance information (e.g., the measure of impedance at a given time), the machine learning models can be trained to evaluate dynamic impedance signals over time, such as the rate of the impedance change, the direction of the impedance change, and the like. These dynamic signals can provide improved model accuracy and reliability, in some aspects, as compared to single point measurements.

### Example Graph Depicting Impedance Information for Proximity Detection Using Machine Learning

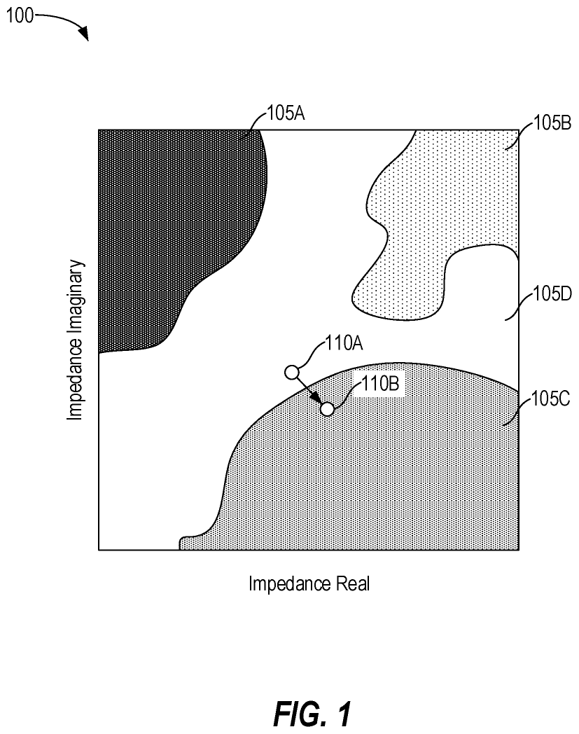

FIG. 1 depicts an example graph 100 illustrating impedance information for proximity detection using machine learning.

Specifically, in the illustrated example, the impedance measurement components are depicted with the “real” component on the horizontal axis and the “imaginary” component on the vertical axis. The illustrated graph 100 further includes a set of regions 105A, 105B, 105C, and 105D (collectively, regions 105) corresponding to different user interaction (UI) situations or cases of the user device. Although four regions 105 (corresponding to four UI cases) are depicted for conceptual clarity, aspects of the present disclosure may be used to predict or classify any number of UI cases. As used herein, the UI case, classification, state, or situation of the device may generally refer to the position of the device relative to humans or other objects, and may include classes such as one or more on-body classifications and/or one or more off-body classifications. For example, one UI case may correspond to when the device is held in the left hand, a second UI case may correspond to when the device is held in the right hand, and the like.

For example, in the illustrated graph 100, the region 105A may correspond to the impedance information when the device is held in a user's left hand, the region 105B may correspond to the impedance information when the device is held in a user's right hand, the region 105C may correspond to the impedance information when the device is held in both hands, the region 105D may correspond to the impedance information when the device is in free space (e.g., resting on a table or other surface and not in contact or proximity with a user), and the like. That is, in some aspects, the specific UI case of the device may theoretically be inferred or determined based on graphing collected impedance information on the graph 100.

However, although the illustrated example suggests clear delineations between UI cases (e.g., where the borders between regions 105 are well-defined and can be accurately determined, such as based on experimentation), reality is much less clear, and there is generally substantial overlap and/or blur between UI cases. Additionally, the specific positions and borders of the UI cases often vary substantially based on factors such as the specific hardware of the device, the RF frequency or frequencies being used by the device, the RF configuration being used (e.g., when and how well antenna tuners are used to improve transmissions), and the like. Moreover, even two devices of the same model often have different impedance characteristics due to factors such as manufacturing spread and variability.

Accordingly, it is often impractical or impossible to accurately characterize UI cases based on such static graphs and measurements. In some aspects of the present disclosure, by considering dynamic impedance information (e.g., changes over time), machine learning models can be trained and used to provide accurate UI classification. In the illustrated graph 100, for example, a first point 110A corresponding to impedance information collected or measured for a first point or window of time is depicted. Further, a second point 110B is depicted corresponding to the impedance information collected or measured for a second point or window of time. As illustrated by the arrow connecting points 110A and 110B, the change in impedance information may be determined and evaluated to drive improved proximity detection.

That is, the change or difference between the impedance measurements at point 110A and 110B may be evaluated using machine learning to more accurately classify the UI case of the device (e.g., to predict whether, at the time represented by point 110B, the device is on-body or off-body). As the borders between regions (e.g., between regions 105D and 105C) are often unclear and may be characterized by substantial overlap, a single impedance measurement at either point 110A or 110B may not be realistically classifiable. However, by considering movement or change of the measurements, aspects of the present disclosure are able to provide more accurate classifications, as discussed in more detail below.

### Example Workflow for Training and Using Machine Learning Models to Provide Proximity Detection Based on Impedance Information

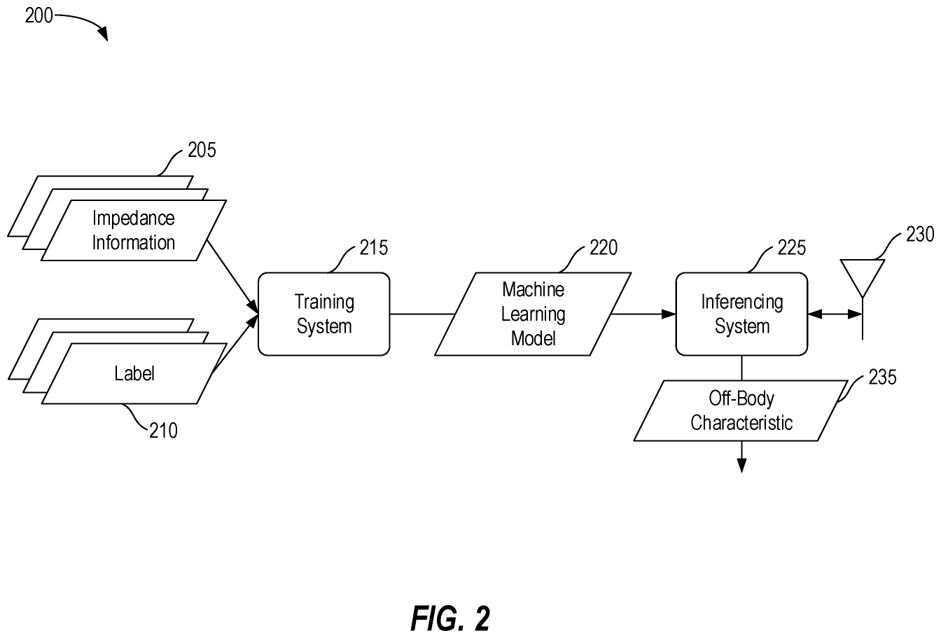

FIG. 2 depicts an example workflow 200 for training and using machine learning models to provide proximity detection based on impedance information.

In the illustrated example, impedance information 205 and corresponding labels 210 are accessed by a training system to train a machine learning model 220. As used herein, “accessing data” may generally refer to receiving, retrieving, requesting, obtaining, or otherwise gaining access to the data, including from a single source, multiple sources, local source(s), and/or remote source(s). For example, although the depicted example suggests the training system 215 accesses the impedance information 205 and labels 210 from an external source for conceptual clarity, in aspects, the impedance information 205 and labels 210 may be accessed from any suitable source or repository. In some aspects, the impedance information 205 and labels 210 may collectively be referred to as training data, training records, training samples, training exemplars, training characterizations, impedance characterization records, and the like.

Generally, the impedance information 205 may characterize the antenna impedance of user devices in various UI cases. That is, each instance of the impedance information 205 may include or indicate the measured impedance for a user device at a given point in time (e.g., the real impedance value and imaginary impedance value collected by a feedback-based component, as discussed above). Additionally, each instance of the impedance information 205 may have a corresponding label 210 indicating the UI case of the user device at the time when the impedance information 205 was collected or measured. In some aspects, the labels 210 may be referred to as ground-truth labels. For example, as discussed above, each label 210 may indicate whether the device was on-body or off-body. As used herein, “on-body” generally refers to the device being in physical contact with a human or within a defined (small) distance from a human. Similarly, “off body” generally refers to the device being not in physical contact with a human and not within a defined (small) distance. Generally, the number and granularity of the UI cases reflected by the labels 210 may vary depending on the particular implementation. For example, in some aspects, the labels 210 are binary (e.g., indicating on-body or off-body). In some aspects, the labels 210 can include further categorical information, such as to distinguish between the left hand, right hand, and two hands on-body cases.

Although training a single machine learning model 220 is depicted for conceptual clarity, in some aspects, the training system 215 may train multiple such models. For example, in some aspects, a separate model may be trained for each UI case (e.g., a first model trained to predict whether the device is in the left hand or not, a second model trained to predict whether the device is in the right hand or not, and the like). In some aspects, a single machine learning model 220 can be trained to predict multiple UI classes, and/or to predict broadly whether the device is on-body or off-body.

In some aspects, the training system 215 uses a subset of training records corresponding to extrema when training the machine learning model 220. That is, the training system 215 may use characterization records of impedance information 205 that are sufficiently similar to a given UI class and/or records that are sufficiently dissimilar to a given UI class to train the model. For example, the training system 215 may use the top and bottom 5% of training records (e.g., the records that are most similar to one or more off-body cases, and the records that are most dissimilar to one or more off-body cases) when training the model. In some aspects, this may involve the training system 215 selectively using records (e.g., selecting which examples are impedance information 205 to use), or the accessed impedance information 205 may be pre-filtered based on such thresholds or other criteria.

Generally, the particular techniques used to train the machine learning model 220 may vary depending on the particular architecture and implementation. For example, if a neural network architecture is used, then the training system 215 may process impedance information 205 (or the difference between two records of impedance information 205) using the model to generate an output (e.g., an off-body characteristic or measure indicating the probability that the device is in one or more off-body cases). This output can be compared against the corresponding label 210 to generate a loss, and the loss may be used to refine or update the parameters (e.g., weights and/or biases) of the model (e.g., using backpropagation).

In the illustrated workflow 200, once the machine learning model 220 is trained, the model can be deployed to one or more inferencing systems 225. Although depicted as discrete systems for conceptual clarity, in some aspects, the training system 215 and inferencing system 225 may be combined as a single system. That is, a single device or system may both train the machine learning model 220 and use the trained machine learning model 220 for inferencing.

In some aspects, the inferencing system 225 generally corresponds to a device (e.g., a UE such as a smartphone) that includes wireless communication capabilities, such as via the antenna 230. As discussed above, in some aspects, the inferencing system 225 can generally use one or more techniques or components to collect, measure, or otherwise determine impedance information for the antenna 230 or for at least a portion of an overall wireless transmitter.

In the illustrated example, the inferencing system 225 can evaluate the impedance information using the trained machine learning model 220 to generate off-body characteristics 235. Generally, the off-body characteristic 235 may be indicative of the predicted UI classification of the inferencing system 225 and/or antenna 230, such as whether the antenna or device is in free space, in the left hand, in the right hand, plugged into a charging cable (e.g., a USB cable), and the like. In some aspects, the off-body characteristic 235 comprises a binary (e.g., a Boolean) or categorical classification indicating the predicted UI case. In some aspects, the off-body characteristic 235 may additionally or alternatively include a probability of one or more UI cases, such as using continuous values (e.g., between zero and one).

Generally, the particular content of the off-body characteristic 235 may vary depending on the particular implementation. For example, in some aspects, the off-body characteristic 235 indicates the probability that the inferencing system 225 is off-body. Although referred to as an “off-body” characteristic, in some aspects, the inferencing system 225 may generate an on-body characteristic (e.g., indicating the probability that the inferencing system 220 is on-body). In some aspects, the off-body characteristic 235 can further indicate the specific UI class that is predicted or most probable. In some aspects, the off-body characteristic 235 may also indicate information such as the probability that the inferencing system 225 is plugged in to a charging system. In at least one aspect, a different machine learning model 220 may be used for each such output. For example, a first model may be used to predict whether the inferencing system 225 is off-body, and a second model may be used to predict whether the inferencing system 225 is plugged in and charging.

Although the illustrated example suggests that the inferencing system 225 outputs the off-body characteristic 235, in aspects, the inferencing system 225 may take a variety of actions based on the characteristic. For example, in some aspects, the inferencing system 225 may perform transmit power back-off operations for the associated wireless transmitter (e.g., for the radio used to transmit signals via the antenna 230). That is, in response to determining that the off-body characteristic satisfies one or more criteria (e.g., indicating that the inferencing system 225 is not off-body with sufficient confidence or probability), the inferencing system 225 may reduce transmission power of the radio (e.g., the wireless transmitter). In some aspects, this is referred to as specific absorption rate (SAR) or power density (PD) back-off, and can be used to reduce the RF exposure of the user.

### Example Workflow for Augmenting Impedance Information to Provide Machine-Learning-Based Proximity Detection

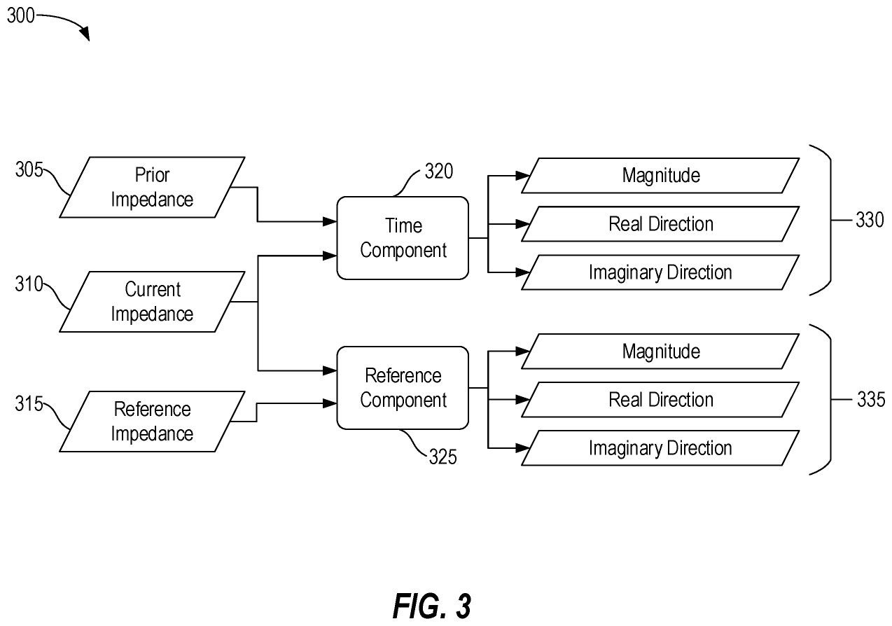

FIG. 3 depicts an example workflow 300 for augmenting impedance information to provide machine-learning-based proximity detection. In some aspects, the workflow 300 is performed by a computing system to generate or determine impedance change information during training and/or during inferencing. For example, the workflow 300 may be performed by a training system (such as training system 215 of FIG. 2) to generate model input during training, and/or by an inferencing system (such as inferencing system 225 of FIG. 2) to generate model input during runtime.

In the illustrated workflow 300, current impedance information 310, prior impedance information 305, and reference impedance information 315 are evaluated to generate time data 330 and reference data 335. Generally, the current impedance information 310 (which may be referred to as index impedance information in some aspects) may correspond to a current or most-recent impedance measurement for the computing system, while the prior impedance information 305 corresponds to at least one impedance measurement from at least one prior point in time, relative to the current impedance information 310 (e.g., the immediately prior measurement, the measurement from a defined length of time, such as one second ago, and the like).

In some aspects, the reference impedance information 315 may correspond to a representative or reference point or measurement for a defined UI class, such as for free space (e.g., a free space reference point, a right hand reference point, and the like), and/or for categories of UI classes (e.g., for any off-body reference points). In some aspects, different reference UI classes may be used depending on the particular implementation. For example, in some aspects, the computing system may use reference impedance information 315 for a first UI class (e.g., for free space) when training a model to predict the first UI class, and use reference impedance information 315 for a second UI class (e.g., for a plugged in/charging class) when training a model to predict the second UI class. In some aspects, the reference impedance information 315 for a given UI class may generally correspond to a representative (e.g., average) impedance measurement for the given UI class.

In the illustrated example, a time component 320 can evaluate the prior impedance information 305 and current impedance information 310 to generate time data 330 including a magnitude of the impedance change or difference over time (e.g., from the prior impedance information 305 to the current impedance information 310) (indicated as “Magnitude” in the illustrated example), a directionality of the change or difference with respect to the real impedance value (indicated as “Real Direction” in the illustrated example), and/or a directionality of the change or difference with respect to the imaginary impedance value (indicated as “Imaginary Direction” in the illustrated example). In at least one aspect, the magnitude of the time data 330 may be defined as Mₜ=\sqrt{(Rₜ−Rₜ₋₁)²+(Iₜ−Iₜ₋₁)²}, where Mₜ is the magnitude of the difference between the current impedance information 310 and the prior impedance information 305 at time t, Rₜ is the real component of the current impedance information 310, Rₜ₋₁ is the real component of the prior impedance information 305, It is the imaginary component of the current impedance information 310, and Iₜ₋₁ is the imaginary component of the prior impedance information 305.

Δ_{Rt}=sign(Rₜ−Rₜ₋₁)Δ_{Rt}Δ_{It}=sign(Iₜ−Iₜ₋₁)Δ_{It} In some aspects, the real direction of the time data 330 is defined as

Δ_{Rt}=sign(Rₜ−Rₜ₋₁)Δ_{Rt}Δ_{It}=sign(Iₜ−Iₜ₋₁)Δ_{It}, where is the direction of the difference of the real components of the current impedance information 310 and the prior impedance information 305. Similarly, in some aspects, the imaginary direction of the time data 330 is defined as, where is the direction of the difference of the imaginary components of the current impedance information 310 and the prior impedance information 305.

In the illustrated example, a reference component 325 can evaluate the current impedance information 310 and the reference impedance information 315 to generate reference data 335 including a magnitude of the impedance difference between the current impedance information 310 and the reference impedance information 315 (indicated as “Magnitude” in the illustrated example), a directionality of the difference with respect to the real impedance value (indicated as “Real Direction” in the illustrated example), and/or a directionality of the difference with respect to the imaginary impedance value (indicated as “Imaginary Direction” in the illustrated example). In at least one aspect, the magnitude of the reference data 335 may be defined as M_{ref}=\sqrt{(Rₜ−R_{ref})²+(Iₜ−I_{ref})²}, where M_{ref} is the magnitude of the difference between the current impedance information 310 and the reference impedance information 315, R_{ref} is the real component of the reference impedance information 315, and I_{ref} is the imaginary component of the reference impedance information 315.

Δ_{Rref}=sign(Rₜ−R_{ref})Δ_{Rref}ΔI_{ref}=sign(Iₜ−I_{ref})Δ_{Iref} In some aspects, the real direction of the reference data 335 is defined as

Δ_{Rref}=sign(Rₜ−R_{ref})Δ_{Rref}Δ_{Iref}=sign(Iₜ−I_{ref})Δ_{Iref}, where is the direction of the difference of the real components of the current impedance information 310 and the reference impedance information 315. Similarly, in some aspects, the imaginary direction of the reference data 335 is defined as, where is the direction of the difference of the imaginary components of the current impedance information 310 and the reference impedance information 315.

In this way, the computing system can generate six impedance change or difference measurements (three values for the time data 330, and three values for the reference data 335) based on the current impedance information 310, prior impedance information 305, and reference impedance information 315. In some aspects, these six measurements are used as the input to the machine learning model. Although depicted as discrete components for conceptual clarity, in some aspects, the operations of the time component 320 and reference component 325 may be combined or distributed across any number of components.

In some aspects, each time a current impedance measurement becomes available (or each time a prediction of the UI class of the device is desired), the workflow 300 may be used to generate corresponding input to the machine learning model. Similarly, during training, the workflow 300 may be used for each training impedance characterization record (e.g., using each index impedance as current impedance information 310) to generate the training inputs.

### Example Method for Augmenting Impedance Information to Provide Machine-Learning-Based Proximity Detection

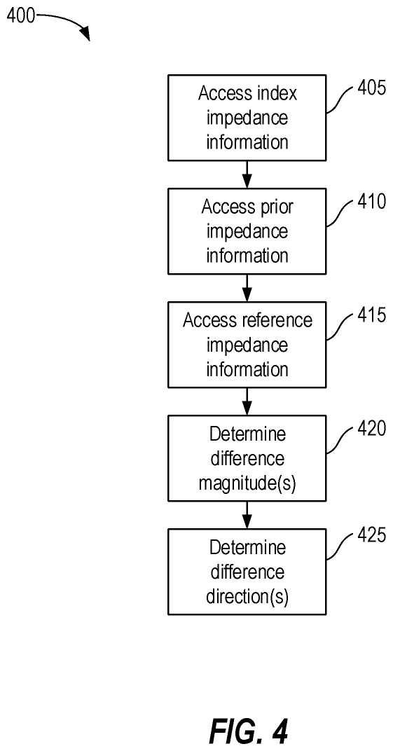

FIG. 4 is a flow diagram depicting an example method 400 for augmenting impedance information to provide machine-learning-based proximity detection. In some aspects, the method 400 is performed by a computing system to generate or determine impedance change information during training and/or during inferencing. For example, the method 400 may be performed by a training system (such as training system 215 of FIG. 2) to generate model input during training, and/or by an inferencing system (such as inferencing system 225 of FIG. 2) to generate model input during runtime. In some aspects, the method 400 corresponds to the workflow 300 of FIG. 3.

At block 405, the computing system accesses index impedance information. In some aspects, index impedance information may correspond to the current information (e.g., current impedance information 310 of FIG. 3). In some aspects, the information may be referred to as “index” impedance information to distinguish this information from prior impedance information collected prior to the index information. That is, because during training the impedance information may not, in fact, be “current,” this information may be referred to in some aspects as “index” to enable ease of reference. In some aspects, during training, the index impedance information may refer to the information for which a corresponding label is being used to train the model.

For example, during inferencing, the computing system may access the index impedance information as the current measurement provided by the impedance measurement component(s). Similarly, during training, the computing system may access the index impedance information as a stored record of impedance that was previously created. As discussed above, the index impedance information can generally include a real component and an imaginary component, and may be collected or measured for a wireless transmitter component of a device.

At block 410, the computing system accesses prior impedance information (e.g., prior impedance information 305 of FIG. 3). In some aspects, the prior impedance information corresponds to measured impedance of the wireless transmitter system at a prior point in time, relative to the index impedance information. For example, during inferencing, the computing system may access the prior impedance information from a memory or storage component. During training, the computing system may access the prior impedance information by selecting the record that was recorded just prior to the index record. In this way, the differences between the prior impedance information and index impedance information may be representative of the movement or motion of the device.

At block 415, the computing system accesses reference impedance information (e.g., reference impedance information 315 of FIG. 3). As discussed above, the reference impedance information generally corresponds to an average or representative impedance measurement for a given UI class being used to train the machine learning model. For example, the representative impedance information may be defined by collecting multiple impedance measurements while the device is in the UI class, and averaging or otherwise aggregating these measurements.

At block 420, the computing system determines one or more difference magnitudes between the accessed impedance information. For example, as discussed above, the computing system may determine the magnitude of the difference between the index impedance information and the prior impedance information, the magnitude of the difference between the index impedance information and the reference impedance information, and the like.

At block 425, the computing system can similarly determine one or more difference directions between the accessed impedance information. For example, as discussed above, the computing system may determine the direction of the difference between the real and/or imaginary components of the index impedance information and the prior impedance information, the direction of the difference between the real and/or imaginary components of the index impedance information and the reference impedance information, and the like.

As discussed above, the method 400 may be used to generate input data for one or more machine learning models during training and/or during inferencing. By using such dynamic impedance change information and reference point information, in some aspects, the computing system is able to train more accurate machine learning models and/or generate more accurate and reliable UI predictions, enabling proximity detection to be performed without the presence or use of capacitive or other conventional proximity sensors. This reduces power use during inferencing, as well as chip size and expense during manufacturing, and generally improves the capabilities and operations of the device itself.

### Example Method for Training Machine Learning Models to Provide Impedance-Based Proximity Detection

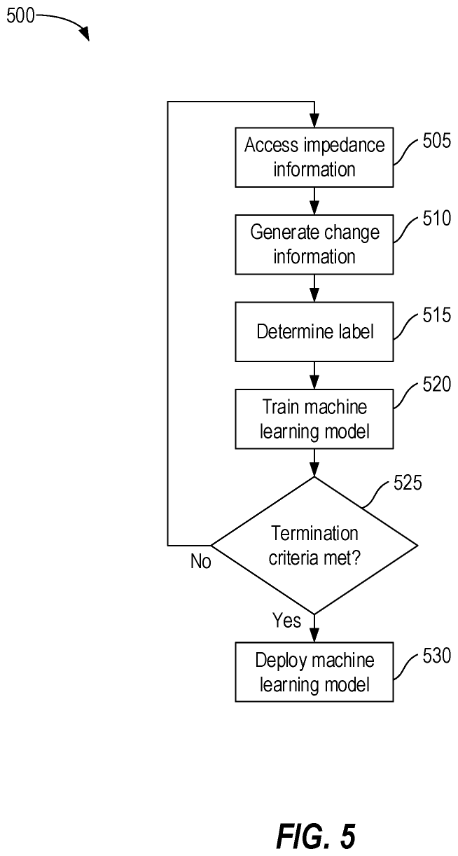

FIG. 5 is a flow diagram depicting an example method 500 for training machine learning models to provide impedance-based proximity detection. In some aspects, the method 500 is performed by a training system (such as training system 215 of FIG. 2).

At block 505, the training system access impedance information (e.g., impedance information 205 of FIG. 2). In some aspects, as discussed above, the impedance information may generally correspond to one or more records of measured impedance for a wireless transmitter at one or more points in time. The impedance information may generally include a real component and an imaginary component for each record. In some aspects, as discussed above, the training system may access or select only a subset of records. For example, with respect to a representative off-body impedance measurement, the training system may select a subset of records that are most similar to the free space reference (e.g., within a defined threshold similarity) and a subset of records that are most dissimilar to the free space reference (e.g., within a defined threshold dissimilarity).

At block 510, the training system generates impedance change or difference information based on the accessed impedance information. For example, as discussed above with reference to FIGS. 3 and 4, the training system may determine the magnitude of the impedance change between an index impedance measurement and the prior impedance measurement and/or between the index impedance measurement and a reference impedance measurement. Additionally, in some aspects, the training system may determine the direction of the differences between the index measurement, the prior measurement, and/or the reference measurement with respect to the real and/or imaginary components of each.

At block 515, the training system determines a label (e.g., label 210 of FIG. 2) for the index impedance information. In some aspects, the label may generally indicate the UI classification of the device at the time when the index impedance information was collected or measured. As discussed above, this label may be relatively specific/granular (e.g., identifying a specific class such as “in the hand”) or relatively high level (e.g., a class that encompasses multiple other classes, such as “on-body” or “off-body”). Generally, the particular contents of the label may vary depending on the particular implementation.

At block 520, the training system trains one or more machine learning models based on the data, as discussed above. That is, the training system trains the model(s) (e.g., updating one or more parameters of the model) using the impedance change or difference information as input and the determined label as target output. In this way, the model learns to predict the UI classification of wireless devices based on impedance information.

At block 525, the training system determines whether one or more training termination criteria have been met. In some aspects, a variety of termination criteria may be used, depending on the particular implementation. For example, the training system may determine whether any training samples remain to be used, whether a defined period of time or amount of computational resources have been spent training, whether the model has reached a minimum or preferred accuracy, and the like.

If the termination criteria are not met, then the method 500 returns to block 505. If the termination criteria are met, then the method 500 continues to block 530, where the training system deploys the machine learning model(s) for inferencing. Generally, deploying the model(s) can include a variety of operations to provide the model(s) for inferencing, including packaging the model, transmitting the learned parameters, and the like. As discussed above, the model(s) may generally be deployed locally (e.g., used by the training system for inferencing) and/or to one or more other systems (e.g., to dedicated inferencing systems, to user devices having wireless capabilities, and the like).

### Example Method for Using Machine Learning Models to Provide Impedance-Based Proximity Detection

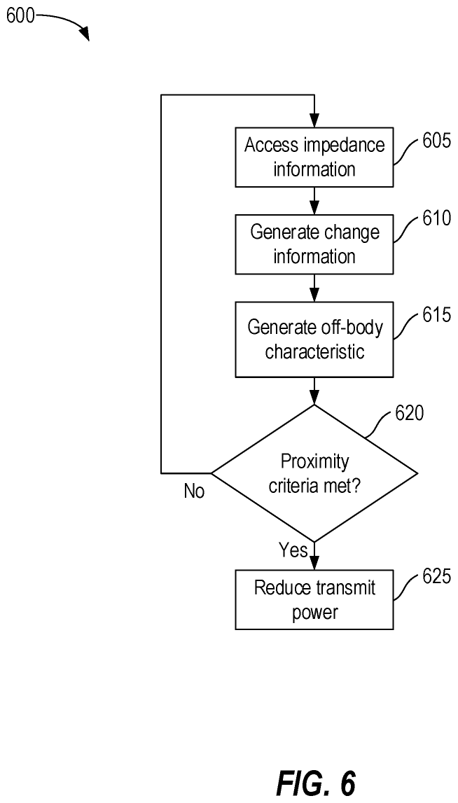

FIG. 6 is a flow diagram depicting an example method 600 for using machine learning models to provide impedance-based proximity detection. In some aspects, the method 600 is performed by an inferencing system (such as inferencing system 225 of FIG. 2). In some aspects, as discussed above, the inferencing system corresponds to a user device (e.g., UE) such as a smartphone.

At block 605, the inferencing system access impedance information (e.g., impedance information 205 of FIG. 2). In some aspects, as discussed above, the impedance information may generally correspond to one or more records of measured impedance for a wireless transmitter at one or more points in time. The impedance information may generally include a real component and an imaginary component for each record. In some aspects, the inferencing system accesses the impedance information as this information is collected or measured (e.g., by feedback components).

At block 610, the inferencing system generates impedance change or difference information based on the accessed impedance information. For example, as discussed above with reference to FIGS. 3 and 4, the inferencing system may determine the magnitude of the impedance change between the current impedance measurement and a prior impedance measurement and/or between the current impedance measurement and a reference impedance measurement. Additionally, in some aspects, the inferencing system may determine the direction of the differences between the current measurement, the prior measurement, and/or the reference measurement with respect to the real and/or imaginary components of each.

At block 615, the inferencing system generates an off-body characteristic by processing the impedance change information using one or more trained machine learning models. The off-body characteristic may generally indicate whether the user device is off-body or on-body, as discussed above. For example, the off-body characteristic may indicate a binary classification (e.g., indicating “off-body” versus “on-body”). In some aspects, the off-body characteristic indicates a class from a multiclass classification set (e.g., “in left hand,” “in right hand,” “in both hands,” “in hand and plugged in/charging,” and the like). In some aspects, the off-body characteristic indicates the probability or confidence in the prediction. In some aspects, as discussed above, the inferencing system may use one model, or multiple models, to generate the off-body characteristic(s). For example, a first model may evaluate the change information to generate an off-body characteristic indicating whether the device is off-body, and a second model may evaluate the change information to generate a charging characteristic indicating whether the device is plugged in.

At block 620, the inferencing system can determine whether one or more proximity criteria are met based on the off-body characteristic. For example, the inferencing system may determine whether a specific predicted UI class matches one or more defined on-body classes, whether the on-body probability meets or exceeds a threshold value, and the like. If the proximity criteria are not met, then the method 600 returns to block 605. In this way, the inferencing system can iteratively or repeatedly generate and evaluate off-body characteristics.

If, at block 620, the inferencing system determines that the proximity criteria are satisfied, then the method 600 continues to block 625. At block 625, the inferencing system can perform power back-off operations by reducing transmission power of one or more transmitter systems, as discussed above. This can reduce the RF exposure of human users when such users are in proximity to the device, as discussed above.

### Example Method for Impedance-Based Proximity Detection

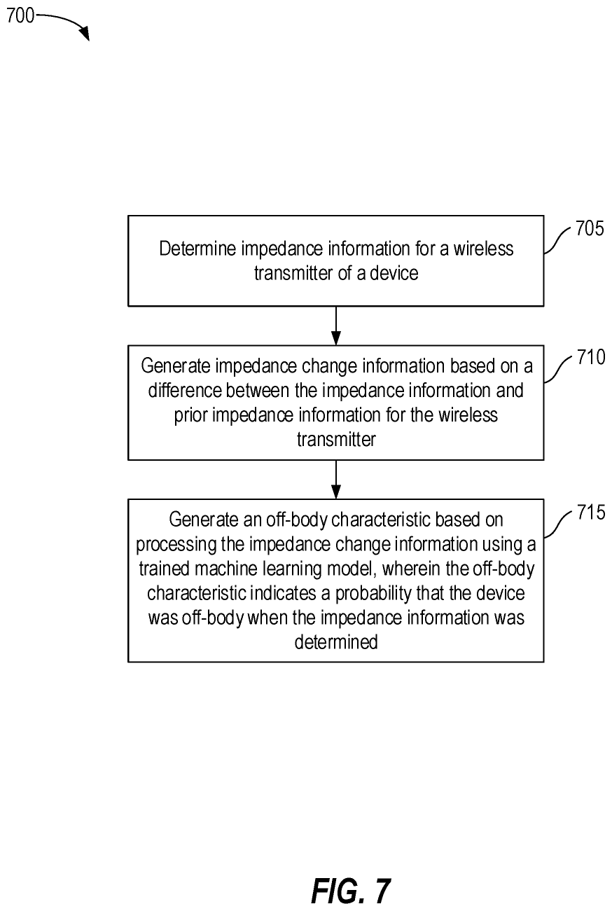

FIG. 7 is a flow diagram depicting an example method 700 for impedance-based proximity detection. In some aspects, the method 700 is performed by an inferencing system, such as inferencing system 225 of FIG. 2.

At block 705, impedance information for a wireless transmitter of a device is determined.

At block 710, impedance change information is generated based on a difference between the impedance information and prior impedance information for the wireless transmitter.

At block 715, an off-body characteristic is generated based on processing the impedance change information using a trained machine learning model, wherein the off-body characteristic indicates a probability that the device was off-body when the impedance information was determined.

In some aspects, the method 700 further includes performing power back-off operations for the wireless transmitter based on the off-body characteristic.

In some aspects, performing the power back-off operations comprises reducing transmission power of the wireless transmitter based on determining that the off-body characteristic satisfies one or more criteria indicating that the device was not off-body when the impedance information was determined.

In some aspects, generating the impedance change information comprises generating a first value representing a magnitude of the difference between the impedance information and the prior impedance information, and generating a second value representing a direction of the difference between the impedance information and the prior impedance information.

In some aspects, the second value indicates the direction of the difference between a real component of the impedance information and a real component of the prior impedance information, and generating the impedance change information further comprises generating a third value representing a direction of the difference between an imaginary component of the impedance information and an imaginary component of the prior impedance information.

In some aspects, generating the impedance change information further comprises generating a third value representing a magnitude of the difference between the impedance information and an off-body reference point, and generating a fourth value representing a direction of the difference between the impedance information and the off-body reference point.

In some aspects, the fourth value indicates the direction of the difference between a real component of the impedance information and a real component of the off-body reference point, and generating the impedance change information further comprises generating a fifth value representing a direction of the difference between an imaginary component of the impedance information and an imaginary component of the off-body reference point.

In some aspects, the method 700 further includes generating a charging characteristic based on processing the impedance change information using the trained machine learning model, wherein the charging characteristic indicates a probability that a charging cable was plugged into the device when the impedance information was determined.

In some aspects, the trained machine learning model is used to provide proximity detection, and the device does not include a capacitive sensor for proximity detection.

In some aspects, the trained machine learning model was trained based on a set of impedance characterization records, the set comprising: a first subset of impedance characterization records, wherein each respective impedance characterization record in the first subset was selected for training the trained machine learning model based on determining that the respective impedance characterization has at least a threshold similarity to an off-body reference point, and a second subset of impedance characterization records, wherein each respective impedance characterization record in the second subset was selected for training the trained machine learning model based on determining that the respective impedance characterization has at least a threshold dissimilarity to an off-body reference point.

### Example Method for Training Models for Impedance-Based Proximity Detection

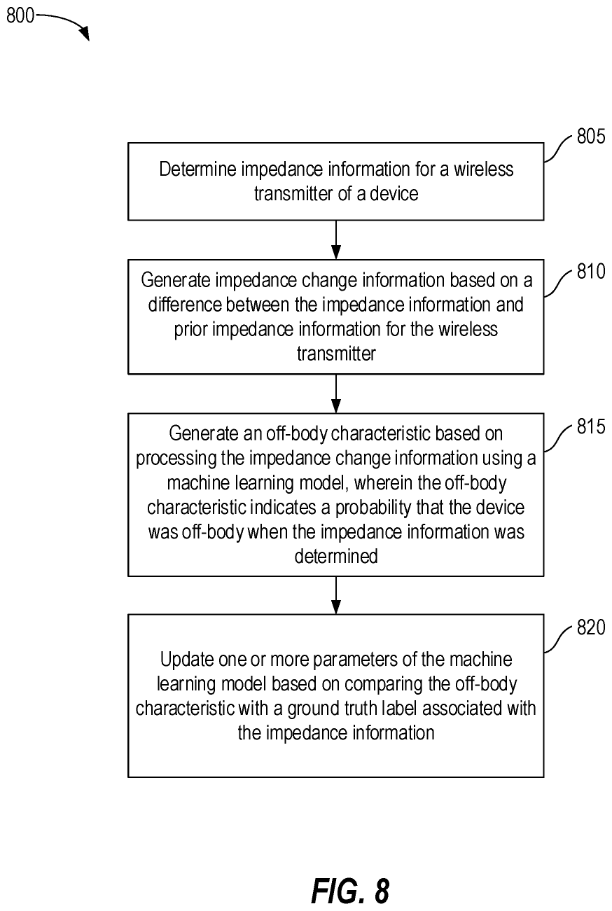

FIG. 8 is a flow diagram depicting an example method 800 for training models for impedance-based proximity detection. In some aspects, the method 800 is performed by a training system, such as training system 215 of FIG. 2.

At block 805, impedance information for a wireless transmitter of a device is determined.

At block 810, impedance change information is generated based on a difference between the impedance information and prior impedance information for the wireless transmitter.

At block 815, an off-body characteristic is generated based on processing the impedance change information using a machine learning model, wherein the off-body characteristic indicates a probability that the device was off-body when the impedance information was determined.

At block 820, one or more parameters of the machine learning model are updated based on comparing the off-body characteristic with a ground truth label associated with the impedance information.

In some aspects, generating the impedance change information comprises generating a first value representing a magnitude of the difference between the impedance information and the prior impedance information, and generating a second value representing a direction of the difference between the impedance information and the prior impedance information.

In some aspects, the second value indicates the direction of the difference between a real component of the impedance information and a real component of the prior impedance information, and generating the impedance change information further comprises generating a third value representing a direction of the difference between an imaginary component of the impedance information and an imaginary component of the prior impedance information.

In some aspects, generating the impedance change information further comprises generating a third value representing a magnitude of the difference between the impedance information and an off-body reference point, and generating a fourth value representing a direction of the difference between the impedance information and the off-body reference point.

In some aspects, the fourth value indicates the direction of the difference between a real component of the impedance information and a real component of the off-body reference point, and generating the impedance change information further comprises generating a fifth value representing a direction of the difference between an imaginary component of the impedance information and an imaginary component of the off-body reference point.

In some aspects, the method further includes updating the one or more parameters of the machine learning model based further on a set of impedance characterization records, the set comprising a first subset of impedance characterization records, wherein each respective impedance characterization record in the first subset was selected for training the machine learning model based on determining that the respective impedance characterization has at least a threshold similarity to an off-body reference point, and a second subset of impedance characterization records, wherein each respective impedance characterization record in the second subset was selected for training the machine learning model based on determining that the respective impedance characterization has at least a threshold dissimilarity to an off-body reference point.

### Example Processing System Machine Learning

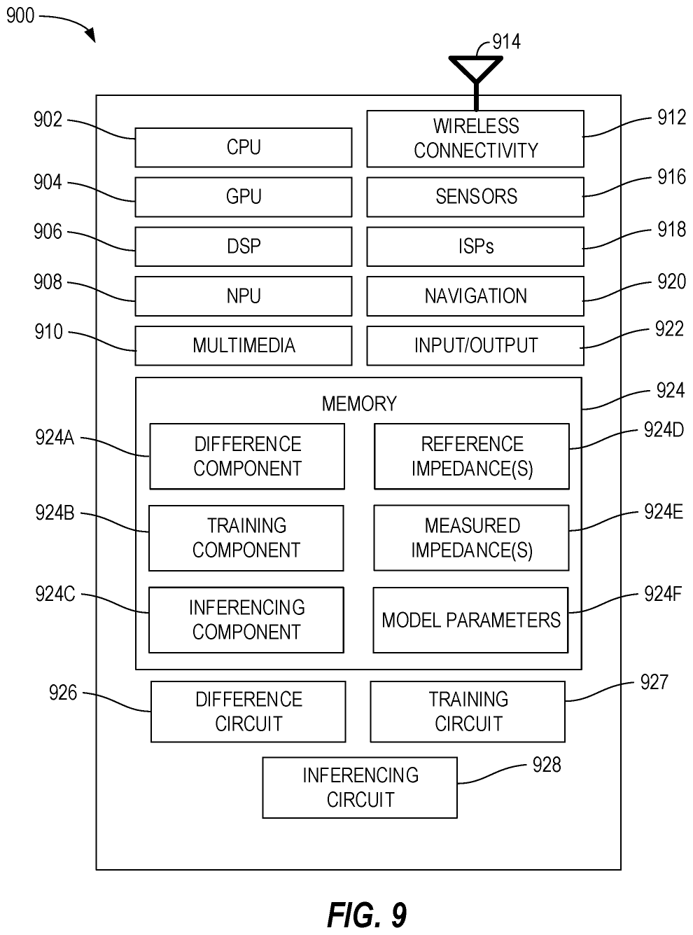

In some aspects, the workflows, techniques, and methods described with reference to FIGS. 1-8 may be implemented on one or more devices or systems. FIG. 9 depicts an example processing system 900 configured to perform various aspects of the present disclosure, including, for example, the techniques and methods described with respect to FIGS. 1-8. In some aspects, the processing system 900 may correspond to a machine learning system, such as the training system 215 of FIG. 2 and/or the inferencing system 225 of FIG. 2. Although depicted as a single system for conceptual clarity, in at least some aspects, as discussed above, the operations described below with respect to the processing system 900 may be distributed across any number of devices or systems (e.g., one device may be used to train the model(s), while another is used to inference).

Processing system 900 includes a central processing unit (CPU) 902, which in some examples may be a multi-core CPU. Instructions executed at the CPU 902 may be loaded, for example, from a program memory associated with the CPU 902 or may be loaded from a memory partition (e.g., a partition of memory 924).

Processing system 900 also includes additional processing components tailored to specific functions, such as a graphics processing unit (GPU) 904, a digital signal processor (DSP) 906, a neural processing unit (NPU) 908, a multimedia component 910 (e.g., a multimedia processing unit), and a wireless connectivity component 912.

An NPU, such as NPU 908, is generally a specialized circuit configured for implementing the control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as NPU 908, are configured to accelerate the performance of common machine learning tasks, such as image classification, machine translation, object detection, and various other predictive models. In some examples, a plurality of NPUs may be instantiated on a single chip, such as a system on a chip (SoC), while in other examples the NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this piece of data through an already trained model to generate a model output (e.g., an inference).

In some implementations, NPU 908 is a part of one or more of CPU 902, GPU 904, and/or DSP 906.

In some examples, wireless connectivity component 912 may include subcomponents, for example, for third generation (3G) connectivity, fourth generation (4G) connectivity (e.g., 4G LTE), fifth generation connectivity (e.g., 5G or NR), Wi-Fi connectivity, Bluetooth connectivity, and other wireless communication standards. Wireless connectivity component 912 is further connected to one or more antennas 914.

Processing system 900 may also include one or more sensor processing units 916 associated with any manner of sensor, one or more image signal processors (ISPs) 918 associated with any manner of image sensor, and/or a navigation processor 920, which may include satellite-based positioning system components (e.g., GPS or GLONASS) as well as inertial positioning system components.

Processing system 900 may also include one or more input and/or output devices 922, such as screens, touch-sensitive surfaces (including touch-sensitive displays), physical buttons, speakers, microphones, and the like.

In some examples, one or more of the processors of processing system 900 may be based on an ARM or RISC-V instruction set.

Processing system 900 also includes memory 924, which is representative of one or more static and/or dynamic memories, such as a dynamic random access memory, a flash-based static memory, and the like. In this example, memory 924 includes computer-executable components, which may be executed by one or more of the aforementioned processors of processing system 900.

In particular, in this example, memory 924 includes a difference component 924A, a training component 924B, and an inferencing component 924C. The memory 924 also includes a set of reference impedances 924D, measured impedances 924E, and model parameters 924F. Though depicted as discrete components for conceptual clarity in FIG. 9, the illustrated components (and others not depicted) may be collectively or individually implemented in various aspects.

The reference impedances 924D may generally correspond to average or representative impedance measurements for one or more UI classes, as discussed above. Measured impedances 924E may generally correspond to one or more measurements of impedance information for a device. For example, in the case of training, the measured impedances 924E may correspond to training samples. In the case of inferencing, the measured impedances 924E may include the current measured impedance and/or one or more prior impedance measurements. The model parameters 924F may generally correspond to the parameters of one or more models (e.g., machine learning model 220 of FIG. 2), such as weights and/or biases.

Processing system 900 further comprises difference circuit 926, training circuit 927, and inferencing circuit 928. The depicted circuits, and others not depicted, may be configured to perform various aspects of the techniques described herein.

For example, difference component 924A and difference circuit 926 may be used to determine or generate impedance change information based on differences between current and prior impedance measurements, between current and reference impedance information, and the like, as discussed above. Training component 924B and training circuit 927 may be used to train machine learning models to perform proximity detection/generate UI classifications based on impedance information, as discussed above. Inferencing component 924C and inferencing circuit 928 may be used to perform proximity detection/generate UI classifications using machine learning models and based on impedance information, as discussed above.

Though depicted as separate components and circuits for clarity in FIG. 9, difference circuit 926, training circuit 927, and inferencing circuit 928 may collectively or individually be implemented in other processing devices of processing system 900, such as within CPU 902, GPU 904, DSP 906, NPU 908, and the like.

Generally, processing system 900 and/or components thereof may be configured to perform the methods described herein.

Notably, in other aspects, aspects of processing system 900 may be omitted, such as where processing system 900 is a server computer or the like. For example, multimedia component 910, wireless connectivity component 912, sensor processing units 916, ISPs 918, and/or navigation processor 920 may be omitted in other aspects. Further, aspects of processing system 900 maybe distributed between multiple devices.

### Example Clauses

Implementation examples are described in the following numbered clauses:

Clause 1: A method, comprising: determining impedance information for a wireless transmitter of a device; generating impedance change information based on a difference between the impedance information and prior impedance information for the wireless transmitter; and generating an off-body characteristic based on processing the impedance change information using a trained machine learning model, wherein the off-body characteristic indicates a probability that the device was off-body when the impedance information was determined.

Clause 2: A method according to Clause 1, further comprising performing power back-off operations for the wireless transmitter based on the off-body characteristic.

Clause 3: A method according to any of Clauses 2, wherein performing the power back-off operations comprises reducing transmission power of the wireless transmitter based on determining that the off-body characteristic satisfies one or more criteria indicating that the device was not off-body when the impedance information was determined.

Clause 4: A method according to any of Clauses 1-3, wherein generating the impedance change information comprises: generating a first value representing a magnitude of the difference between the impedance information and the prior impedance information; and generating a second value representing a direction of the difference between the impedance information and the prior impedance information.

Clause 5: A method according to any of Clauses 4, wherein: the second value indicates the direction of the difference between a real component of the impedance information and a real component of the prior impedance information, and generating the impedance change information further comprises generating a third value representing a direction of the difference between an imaginary component of the impedance information and an imaginary component of the prior impedance information.

Clause 6: A method according to any of Clauses 4, wherein generating the impedance change information further comprises: generating a third value representing a magnitude of the difference between the impedance information and an off-body reference point; and generating a fourth value representing a direction of the difference between the impedance information and the off-body reference point.

Clause 7: A method according to any of Clauses 6, wherein: the fourth value indicates the direction of the difference between a real component of the impedance information and a real component of the off-body reference point, and generating the impedance change information further comprises generating a fifth value representing a direction of the difference between an imaginary component of the impedance information and an imaginary component of the off-body reference point.

Clause 8: A method according to any of Clauses 1-7, further comprising generating a charging characteristic based on processing the impedance change information using the trained machine learning model, wherein the charging characteristic indicates a probability that a charging cable was plugged into the device when the impedance information was determined.

Clause 9: A method according to any of Clauses 1-8, wherein: the trained machine learning model is used to provide proximity detection, and the device does not include a capacitive sensor for proximity detection.

Clause 10: A method according to any of Clauses 1-9, wherein the trained machine learning model was trained based on a set of impedance characterization records, the set comprising: a first subset of impedance characterization records, wherein each respective impedance characterization record in the first subset was selected for training the trained machine learning model based on determining that the respective impedance characterization has at least a threshold similarity to an off-body reference point; and a second subset of impedance characterization records, wherein each respective impedance characterization record in the second subset was selected for training the trained machine learning model based on determining that the respective impedance characterization has at least a threshold dissimilarity to an off-body reference point.

Clause 11: A method, comprising: determining impedance information for a wireless transmitter of a device; generating impedance change information based on a difference between the impedance information and prior impedance information for the wireless transmitter; generating an off-body characteristic based on processing the impedance change information using a machine learning model, wherein the off-body characteristic indicates a probability that the device was off-body when the impedance information was determined; and updating one or more parameters of the machine learning model based on comparing the off-body characteristic with a ground truth label associated with the impedance information.

Clause 12: A method according to Clause 11, wherein generating the impedance change information comprises: generating a first value representing a magnitude of the difference between the impedance information and the prior impedance information; and generating a second value representing a direction of the difference between the impedance information and the prior impedance information.

Clause 13: A method according to any of Clauses 12, wherein: the second value indicates the direction of the difference between a real component of the impedance information and a real component of the prior impedance information, and generating the impedance change information further comprises generating a third value representing a direction of the difference between an imaginary component of the impedance information and an imaginary component of the prior impedance information.

Clause 14: A method according to any of Clauses 12, wherein generating the impedance change information further comprises: generating a third value representing a magnitude of the difference between the impedance information and an off-body reference point; and generating a fourth value representing a direction of the difference between the impedance information and the off-body reference point.

Clause 15: A method according to any of Clauses 14, wherein: the fourth value indicates the direction of the difference between a real component of the impedance information and a real component of the off-body reference point, and generating the impedance change information further comprises generating a fifth value representing a direction of the difference between an imaginary component of the impedance information and an imaginary component of the off-body reference point.

Clause 16: A method according to any of Clauses 11-15, further comprising updating the one or more parameters of the machine learning model based further on a set of impedance characterization records, the set comprising: a first subset of impedance characterization records, wherein each respective impedance characterization record in the first subset was selected for training the machine learning model based on determining that the respective impedance characterization has at least a threshold similarity to an off-body reference point; and a second subset of impedance characterization records, wherein each respective impedance characterization record in the second subset was selected for training the machine learning model based on determining that the respective impedance characterization has at least a threshold dissimilarity to an off-body reference point.

Clause 17: A processing system, comprising: a memory comprising computer-executable instructions; and one or more processors configured to execute the computer-executable instructions and cause the processing system to perform a method in accordance with any of Clauses 1-16.

Clause 18: A processing system, comprising means for performing a method in accordance with any of Clauses 1-16.

Clause 19: A non-transitory computer-readable medium comprising computer-executable instructions that, when executed by one or more processors of a processing system, cause the processing system to perform a method in accordance with any of Clauses 1-16.

Clause 20: A computer program product embodied on a computer-readable storage medium comprising code for performing a method in accordance with any of Clauses 1-16.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processor-implemented method for proximity detection using machine learning, comprising:
determining impedance information for a wireless transmitter of a device;
generating impedance change information based on a difference between the impedance information and prior impedance information for the wireless transmitter; and
generating an off-body characteristic based on processing the impedance change information using a trained machine learning model, wherein the off-body characteristic indicates a probability that the device was off-body when the impedance information was determined.

2. The processor-implemented method of claim 1, further comprising performing power back-off operations for the wireless transmitter based on the off-body characteristic.

3. The processor-implemented method of claim 2, wherein performing the power back-off operations comprises reducing transmission power of the wireless transmitter based on determining that the off-body characteristic satisfies one or more criteria indicating that the device was not off-body when the impedance information was determined.

4. The processor-implemented method of claim 1, wherein generating the impedance change information comprises:
generating a first value representing a magnitude of the difference between the impedance information and the prior impedance information; and
generating a second value representing a direction of the difference between the impedance information and the prior impedance information.

5. The processor-implemented method of claim 4, wherein:
the second value indicates the direction of the difference between a real component of the impedance information and a real component of the prior impedance information, and
generating the impedance change information further comprises generating a third value representing a direction of the difference between an imaginary component of the impedance information and an imaginary component of the prior impedance information.

6. The processor-implemented method of claim 4, wherein generating the impedance change information further comprises:
generating a third value representing a magnitude of the difference between the impedance information and an off-body reference point; and
generating a fourth value representing a direction of the difference between the impedance information and the off-body reference point.

7. The processor-implemented method of claim 6, wherein:
the fourth value indicates the direction of the difference between a real component of the impedance information and a real component of the off-body reference point, and
generating the impedance change information further comprises generating a fifth value representing a direction of the difference between an imaginary component of the impedance information and an imaginary component of the off-body reference point.

8. The processor-implemented method of claim 1, further comprising generating a charging characteristic based on processing the impedance change information using the trained machine learning model, wherein the charging characteristic indicates a probability that a charging cable was plugged into the device when the impedance information was determined.

9. The processor-implemented method of claim 1, wherein:
the trained machine learning model is used to provide proximity detection, and
the device does not include a capacitive sensor for proximity detection.

10. The processor-implemented method of claim 1, wherein the trained machine learning model was trained based on a set of impedance characterization records, the set comprising:
a first subset of impedance characterization records, wherein each respective impedance characterization record in the first subset was selected for training the trained machine learning model based on determining that the respective impedance characterization has at least a threshold similarity to an off-body reference point; and
a second subset of impedance characterization records, wherein each respective impedance characterization record in the second subset was selected for training the trained machine learning model based on determining that the respective impedance characterization has at least a threshold dissimilarity to the off-body reference point.

11. A processor-implemented method for training machine learning models to perform proximity detection, comprising:
determining impedance information for a wireless transmitter of a device;
generating impedance change information based on a difference between the impedance information and prior impedance information for the wireless transmitter;
generating an off-body characteristic based on processing the impedance change information using a machine learning model, wherein the off-body characteristic indicates a probability that the device was off-body when the impedance information was determined; and
updating one or more parameters of the machine learning model based on comparing the off-body characteristic with a ground truth label associated with the impedance information.

12. The processor-implemented method of claim 11, wherein generating the impedance change information comprises:
generating a first value representing a magnitude of the difference between the impedance information and the prior impedance information; and
generating a second value representing a direction of the difference between the impedance information and the prior impedance information.

13. The processor-implemented method of claim 12, wherein:
the second value indicates the direction of the difference between a real component of the impedance information and a real component of the prior impedance information, and
generating the impedance change information further comprises generating a third value representing a direction of the difference between an imaginary component of the impedance information and an imaginary component of the prior impedance information.

14. The processor-implemented method of claim 12, wherein generating the impedance change information further comprises:
generating a third value representing a magnitude of the difference between the impedance information and an off-body reference point; and
generating a fourth value representing a direction of the difference between the impedance information and the off-body reference point.

15. The processor-implemented method of claim 14, wherein:
the fourth value indicates the direction of the difference between a real component of the impedance information and a real component of the off-body reference point, and
generating the impedance change information further comprises generating a fifth value representing a direction of the difference between an imaginary component of the impedance information and an imaginary component of the off-body reference point.

16. The processor-implemented method of claim 11, further comprising updating the one or more parameters of the machine learning model based further on a set of impedance characterization records, the set comprising:
a first subset of impedance characterization records, wherein each respective impedance characterization record in the first subset was selected for training the machine learning model based on determining that the respective impedance characterization has at least a threshold similarity to an off-body reference point; and
a second subset of impedance characterization records, wherein each respective impedance characterization record in the second subset was selected for training the machine learning model based on determining that the respective impedance characterization has at least a threshold dissimilarity to the off-body reference point.

17. A processing system, comprising:
a memory comprising computer-executable instructions; and
one or more processors configured to execute the computer-executable instructions and cause the processing system to perform an operation comprising:
determining impedance information for a wireless transmitter of the processing system;
generating impedance change information based on a difference between the impedance information and prior impedance information for the wireless transmitter; and
generating an off-body characteristic based on processing the impedance change information using a trained machine learning model, wherein the off-body characteristic indicates a probability that the processing system was off-body when the impedance information was determined.

18. The processing system of claim 17, the operation further comprising performing power back-off operations for the wireless transmitter based on the off-body characteristic.

19. The processing system of claim 18, wherein performing the power back-off operations comprises reducing transmission power of the wireless transmitter based on determining that the off-body characteristic satisfies one or more criteria indicating that the processing system was not off-body when the impedance information was determined.

20. The processing system of claim 17, wherein generating the impedance change information comprises:
generating a first value representing a magnitude of the difference between the impedance information and the prior impedance information; and
generating a second value representing a direction of the difference between the impedance information and the prior impedance information.

21. The processing system of claim 20, wherein:
the second value indicates the direction of the difference between a real component of the impedance information and a real component of the prior impedance information, and
generating the impedance change information further comprises generating a third value representing a direction of the difference between an imaginary component of the impedance information and an imaginary component of the prior impedance information.

22. The processing system of claim 20, wherein generating the impedance change information further comprises:
generating a third value representing a magnitude of the difference between the impedance information and an off-body reference point; and
generating a fourth value representing a direction of the difference between the impedance information and the off-body reference point.

23. The processing system of claim 22, wherein:
the fourth value indicates the direction of the difference between a real component of the impedance information and a real component of the off-body reference point, and
generating the impedance change information further comprises generating a fifth value representing a direction of the difference between an imaginary component of the impedance information and an imaginary component of the off-body reference point.

24. The processing system of claim 17, the operation further comprising generating a charging characteristic based on processing the impedance change information using the trained machine learning model, wherein the charging characteristic indicates a probability that a charging cable was plugged into the processing system when the impedance information was determined.

25. The processing system of claim 17, wherein:
the trained machine learning model is used to provide proximity detection, and
the processing system does not include a capacitive sensor for proximity detection.

26. The processing system of claim 17, wherein the trained machine learning model was trained based on a set of impedance characterization records, the set comprising:
a first subset of impedance characterization records, wherein each respective impedance characterization record in the first subset was selected for training the trained machine learning model based on determining that the respective impedance characterization has at least a threshold similarity to an off-body reference point; and
a second subset of impedance characterization records, wherein each respective impedance characterization record in the second subset was selected for training the trained machine learning model based on determining that the respective impedance characterization has at least a threshold dissimilarity to the off-body reference point.

27. A processing system, comprising:
means for determining impedance information for a wireless transmitter of a processing system;
means for generating impedance change information based on a difference between the impedance information and prior impedance information for the wireless transmitter; and
means for generating an off-body characteristic based on processing the impedance change information using a trained machine learning model, wherein the off-body characteristic indicates a probability that the processing system was off-body when the impedance information was determined.

28. The processing system of claim 27, further comprising means for performing power back-off operations for the wireless transmitter based on the off-body characteristic.

29. The processing system of claim 27, wherein generating the impedance change information comprises:
generating a first value representing a magnitude of the difference between the impedance information and the prior impedance information; and
generating a second value representing a direction of the difference between the impedance information and the prior impedance information.

30. The processing system of claim 27, wherein:
the trained machine learning model is used to provide proximity detection, and
the processing system does not include a capacitive sensor for proximity detection.
